(19) United States
(12) Patent Application Publication
(10) Pub. No.: US 2026/0341262 A1
(43) Pub. Date: Oct. 29, 2026

(54) OVERTAKING CONTROL OF A CONVERSATION USING ARTIFICIAL INTELLIGENCE

(71) Applicant: The Toronto-Dominion Bank, Toronto (CA)

(72) Inventors: Alexandre Dionne, Toronto (CA); Daniel Chan, Toronto (CA); Daniel Chammas, Toronto (CA); Danika Babin-Demers, Toronto (CA); Xuan Qin, Toronto (CA); Ian Wong, Toronto (CA); Alexandre Guertin, Toronto (CA); Debora Santelli, Toronto (CA); Xavier Dubé, Toronto (CA); Simranjit Warraich, Toronto (CA); Rajendra Dharaj, Toronto (CA); Myriam Benzaquen-Lasry, Toronto (CA); Mehran Moghtadai, Toronto (CA)

(73) Assignee: The Toronto-Dominion Bank, Toronto (CA)

(21) Appl. No.: 19/187,348

(22) Filed: Apr. 23, 2025

(51) Int. Cl. G10L 13/00; G10L 15/18

(52) U.S. Cl. CPC G10L 13/00; G10L 15/1822

(57) ABSTRACT

An example operation may include at least one of capturing, by a software application, speech data from a conversation as it occurs during a communication session conducted between a first device and a second device via the software application, identifying, by the software application, a topic of the conversation being discussed during the conversation based on the speech data, determining to overtake control of the conversation by the software application based on the topic, generating conversation content by the software application based on execution of at least one artificial intelligence (AI) model on the speech data, the topic of the conversation, and a database of previously stored conversation content, and outputting, by the software application, the conversation content during the communication session in response to the determination to overtake control. The example operation may further include an AI agent performing an action related to the determination to overtake control.

### BACKGROUND

Communication software for managing inbound and outbound calls such as those that can occur between devices, at a contact center, at public safety access point (PSAP), and the like, provide technology that enables participants of a call to communicate over a public telephone network. Meanwhile, artificial intelligence is a technology that enables computers (and machines) to simulate human behavior and even perform activities that may exceed what humans are capable of performing.

### SUMMARY

One example embodiment provides an apparatus that may include a memory, and at least one processor communicatively coupled to the memory, where the at least one processor may capture, by a software application, speech data from a conversation as it occurs during a communication session conducted between a first device and a second device via the software application, identify, by the software application, a topic of the conversation being discussed during the conversation based on the speech data, determine to overtake control of the conversation by the software application based on the topic and based on a group of topics that are stored within a profile of a participant of the communication session, generate conversation content by the software application based on execution of at least one artificial intelligence (AI) model on the speech data, the topic of the conversation, and a database of previously stored conversation content, and output, by the software application, the conversation content through a talking bot during the communication session.

Another example embodiment provides a method that includes at least one of capturing, by a software application, speech data from a conversation as it occurs during a communication session conducted between a first device and a second device via the software application, identifying, by the software application, a topic of the conversation being discussed during the conversation based on the speech data, determining to overtake control of the conversation by the software application based on the topic, generating conversation content by the software application based on execution of at least one artificial intelligence (AI) model on the speech data, the topic of the conversation, and a database of previously stored conversation content, and outputting, by the software application, the conversation content during the communication session in response to the determination to overtake control.

A further example embodiment provides a computer-readable medium comprising instructions, that when read by a processor, cause the processor to perform at least one of capturing, by a software application, speech data from a conversation as it occurs during a communication session conducted between a first device and a second device via the software application, identifying, by the software application, a topic of the conversation being discussed during the conversation based on the speech data, determining to overtake control of the conversation by the software application based on the topic, generating conversation content by the software application based on execution of at least one artificial intelligence (AI) model on the speech data, the topic of the conversation, and a database of previously stored conversation content, and outputting, by the software application, the conversation content during the communication session in response to the determination to overtake control.

### BRIEF DESCRIPTION OF THE DRAWINGS

FIG. 1A is a diagram illustrating an operating environment of a software service, according to examples and features of the instant solution.

FIG. 1B is a diagram illustrating a computing environment for generating and injecting conversation content into a communication session using artificial intelligence according to examples and features of the instant solution.

FIG. 2A is a system diagram illustrating integration of an AI model into any decision point, according to the examples and features of the instant solution.

FIG. 2B is a diagram illustrating a process for developing an AI model that supports AI assisted computer decision points, according to the examples and features of the instant solution.

FIG. 2C is a diagram illustrating a process for utilizing an AI model that supports AI assisted computer decision points according to examples and features of the instant solution.

FIG. 3 is a system diagram illustrating an operating environment for a communication service according to the examples and features of the instant solution.

FIG. 4A is a diagram illustrating a process of building a profile of topics of weakness according to the examples and features of the instant solution.

FIG. 4B is a diagram illustrating a process of determining to overtake control of a communication session according to the examples and features of the instant solution.

FIG. 4C is a diagram illustrating a process of generating and outputting content during the communication session according to the examples and features of the instant solution.

FIG. 5 is a diagram illustrating a process of muting a plurality of devices participating in a communication session according to the examples and features of the instant solution.

FIG. 6A is a diagram illustrating a process of outputting content through a talking bot according to the examples and features of the instant solution.

FIG. 6B is a diagram illustrating a process of generating a call summary according to the examples and features of the instant solution.

FIGS. 7A-7B are diagrams illustrating a process of switching topics of conversation during a communication session according to the examples and features of the instant solution.

FIG. 8A is a diagram illustrating a method of overtaking control of a communication session according to the examples and features of the instant solution.

FIG. 8B is a diagram illustrating another method of overtaking control of a communication session according to the examples and features of the instant solution.

FIG. 9 is a diagram illustrating a computing system that may be used in any of the examples and features of the instant solution described herein.

### DETAILED DESCRIPTION

It is to be understood that although this disclosure includes a detailed description of cloud computing, implementation of the instant solution recited herein is not limited to a cloud computing environment. Rather, features of the instant solution are capable of being implemented in conjunction with any other type of computing environment now known or later developed.

The examples and features of the instant solution are directed to a system that can capture speech data from a conversation as it occurs during a communication session conducted between a first device and a second device via the software application. The system can identify a topic of the conversation being discussed during the conversation using artificial intelligence (AI) and determine to overtake control of the conversation based on the topic and based on a group of topics that are stored within a profile of a participant of the communication session. Here, the profile may be created by the system which “learns” the topics of weakness of the user over time and stores the topics within the profile. The system can use AI to analyze historical conversation content of the participant to detect topics with which the user typically has trouble (weaknesses). The system can detect the difficulty of the participant based on the speech provided by the participant with respect to the topic. For example, the topic may cause additional pauses from the participant, less content to be spoken, incorrect content to be spoken, etc. This data may be analyzed by the AI to identify whether the topic is a weakness.

The system described herein can generate conversation content based on execution of at least one artificial intelligence (AI) model on the speech data, the topic of the conversation, and a database of previously stored conversation content, and output the conversation content through a talking bot during the communication session. In some examples and features of the instant solution, the system may mute, by a software application, audio from at least one of the first device and the second device participating in the communication session in response to a determination to overtake control of the conversation, and output the conversation content as audio while muting the at least one of the first device and the second device.

In some examples and features of the instant solution, the system may determine the topic based on execution of the at least one AI model on the speech data and determine to overtake control of the conversation when the topic matches at least one topic on a predefined list of topics previously registered with the software application. In some examples and features of the instant solution, the system may use AI to generate a voice for use by the talking bot when speaking the conversation content based on execution of the at least one AI model on the speech data, and output the conversation content through the talking bot using the voice. For example, the voice may mimic a participant voice of the participant of the communication session.

In some examples and features of the instant solution, the system may receive additional speech data of a remainder of the communication session, generate a summary of the conversation based on execution of the at least one AI model on the speech data and the additional speech data, and display the summary of the conversation within a graphical user interface (GUI) of the software application. In some examples and features of the instant solution, the system may determine to change the topic to a different topic based on the topic and based on a script of the communication session, generate different conversation content based on execution of the at least one AI model on the speech data and the different topic, and output the different conversation content through the talking bot during the communication session.

In some examples and features of the instant solution, the at least one AI model may be trained by the system based on at least one of historical conversation content, historical call scripts, and historical profile data. The system may also receive feedback about the conversation content from a GUI of the software application. Furthermore, the system may retrain the at least one AI model based on the conversation content and the feedback about the conversation content.

Related communication software can perform tasks such as enabling a communication session to occur between two devices participating in the communication session. However, the audio in these conversations is generally provided by the participating users. In contrast, in the examples and features of the instant solution, a talking bot can assist with a conversation when a topic has changed to a topic of weakness for a participant. The talking bot can ensure that the conversation continues with valid substance, even when the participant does not know how to respond.

Some of the technical benefits of the examples and features of the instant solution include an AI-system overtaking control of a communication session between two devices. The AI-system can detect when a topic of conversation has shifted to a topic that is a weakness to one of the participants in the communication session and automatically overtake control of the conversation through technical capabilities (e.g., by muting devices participating in the conversation, generating conversation content, speaking the content aloud in the conversation in an automated manner, etc.). The use of the talking bot with the communication session is novel and enables the AI system to “speak” aloud the conversation content without a user to speak such content.

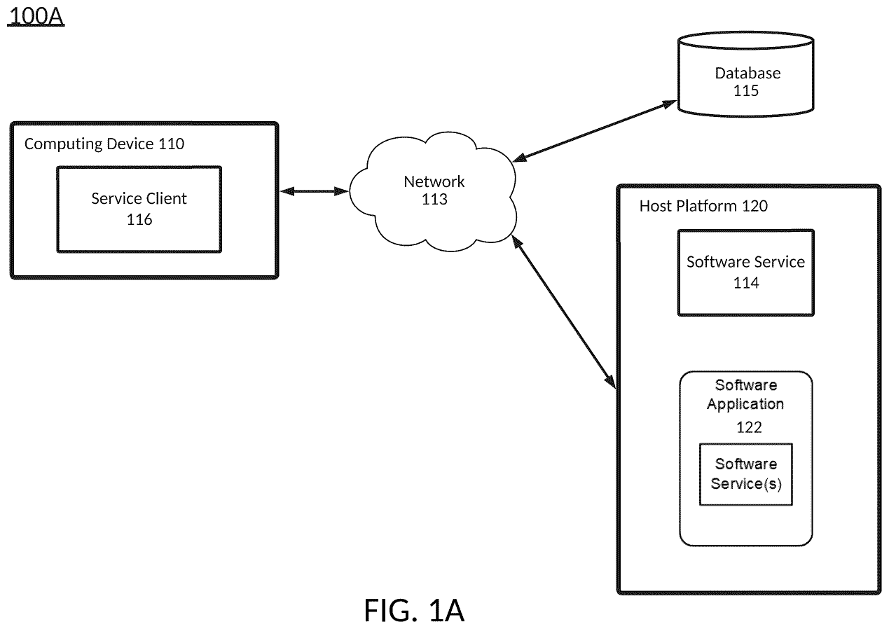

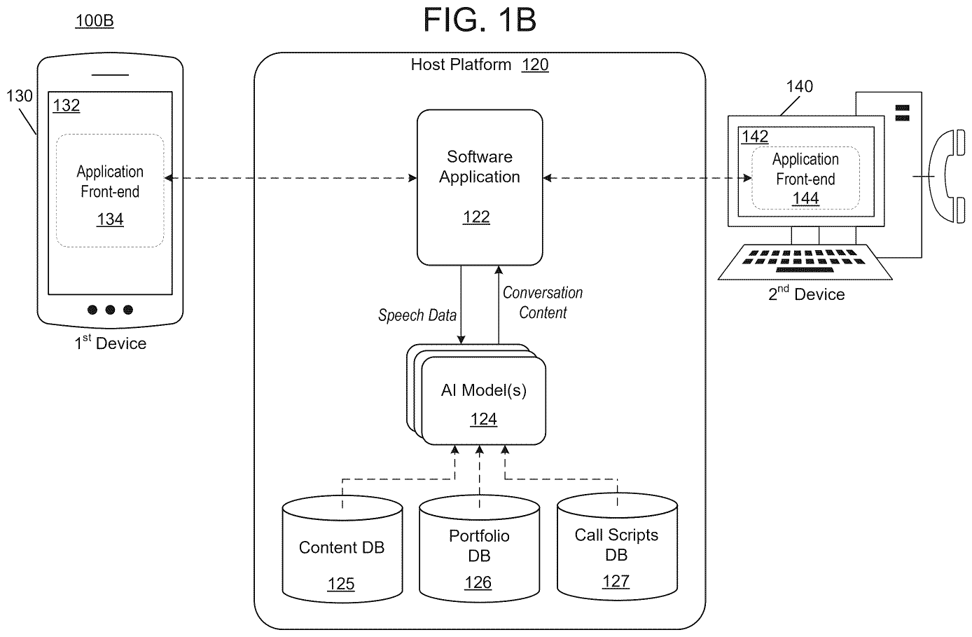

FIG. 1A illustrates an operating environment 100A of the instant solution. As shown, at least one computing device 110, and a host platform 120 communicate via a network 113. The host platform 120 may host a software service 114, a software application 122 containing at least one software service, and the like. The software service 114 and/or the software application 122 may communicate with at least one database 115 through a network 113 during the course of service execution. The computing device 110 may host a service client 116, which communicates with a corresponding software service 114.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 113 is a computer network and may include at least one interconnected computer network. For example, network 113 may be or may include an Ethernet network, an asynchronous transfer mode (ATM) network, a wireless network, a telecommunications network or the like.

The software service 114 provides the service logic. It may provide at least one Application Programming Interface (API) for communicating with at least one service client 116. A “thick” user interface client that runs on a computing device 110 may utilize the APIs to communicate with the software service 114. Further, the software service 114 may provide hosted User Interfaces (UIs) that can be accessed through browser-based software on some computing devices 110.

The software application 122 may include at least one service (e.g., at least one software service 114, etc.) For example, the software application 122 may include or otherwise be made up of a plurality of services that are independently managed with separate A Pls.

The at least one service client 116 can enable service access for end users and may come in a variety of forms including, but not limited to, a mobile device application (“app”) or a web portal accessed via a browser on a computing device 110 such as a laptop or desktop computer.

FIG. 1B illustrates a computing environment 100B for overtaking a communication session with generative content according to examples and features of the instant solution. Referring to FIG. 1B, the host platform 120, such as a cloud platform, web server, etc., may host a communication session, such as a meeting, between a first device 130 and a second device 140 through a software application 122. The host platform 120 may connect to the first device 130 and the second device 140 over a computer network such as a cellular network, the Internet, a private network, and the like.

According to various examples and features of the instant solution, the first device 130 and the second device 140 may be at least one of a mobile device, a computer, a laptop, a desktop computer, a contact center access point, and the like. The first device 130 and the second device 140 may display conversation content from the conversation including text, images, and the like, and play audio (e.g., spoken by a user, spoken by a talking bot, etc.) from the conversation which can be output via speakers (not shown). For example, the first device 130 may also include a microphone (not shown) for capturing audio spoken by a user thereof which is then transferred to the second device 140 via the software application 122. Likewise, the second device 140 may include a microphone (not shown) for capturing audio spoken by a user thereof.

Here, the host platform 120 may host the software application 122 and make it accessible to the first device 130 and the second device 140 at the same time over a computer network such as the Internet. Thus, the first device 130 and the second device 140 may connect for a communication session via the software application 122. For example, the software application 122 may be a mobile application that includes a front-end which is installed on the first device 130 (and the second device 140) and a back-end which is installed on the host platform 120. The software application 122 may be a progressive web application (PWA) that is hosted by the host platform 120 and made accessible via a browser on the second device 140 and/or the first device 130 via an address on the web. The first device 130 and the second device 140 may display a graphical user interface (GUI) output by the software application 122, for example, an application front-end 134 GUI that is shown on a display device 132 of the first device 130, and an application front-end 144 GUI that is shown on a display device 142 of the second device 140.

In the examples and features of the instant solution, the host platform 120 may include one or more artificial intelligence (AI) models including at least one AI model 124 which is capable of ingesting speech data, visual data, audio, etc. from conversation content during a live conversation, and dynamically generate additional conversation content that can be displayed on one or more of the application front-end 134 and the application front-end 144, spoken during the communication session (e.g., by a talking bot) and the like. In some examples and features of the instant solution, the at least one AI model 124 may be trained on one or more of historical topics of conversation content within a data store such as content DB 125, user portfolio data stored in a data store such as portfolio DB 126, call transcripts stored in a data store such as call scripts DB 127, and the like. The host platform 120 may also include one or more additional models including one or more machine learning models, one or more AI models, and the like. The models including the at least one AI model 124 may be held by the host platform 120 within a model repository (not shown).

In the example of FIG. 1B, the first device 130 and the second device 140 may exchange speech, text, images, and the like, communications submitted through the software application 122. For example, audio may be spoken, text may be entered into a text box, documents may be viewed, and the like. The conversation between the users may be recorded by the software application 122, converted into a vector or other encoding, and submitted to the at least one AI model 124. In response, the at least one AI model 124 may dynamically detect topics that are being discussed during the meeting from the conversation content and dynamically generate GUI content to be displayed during the meeting or audio content to be spoken.

In some examples and features of the instant solution, the conversation content that is displayed during the communication session may include content that is visible to the first device 130 and the second device 140 and/or content that is visible to one of the devices. The software application 122 may control which device sees which content and create different experiences on the application front-ends of the first device 130 and the second device 140 during the communication session. Furthermore, the at least one AI model 124 may ingest speech data from the communication session and generate additional content that can be displayed and or spoken during the conversation and additional content that can be used after the communication session such as a call script, a call list, a link, and the like. The at least one AI model 124 may use audio with speech data from the conversation to detect when the conversation changes from one topic to another and modify the generated content or generate additional content in response to such a change.

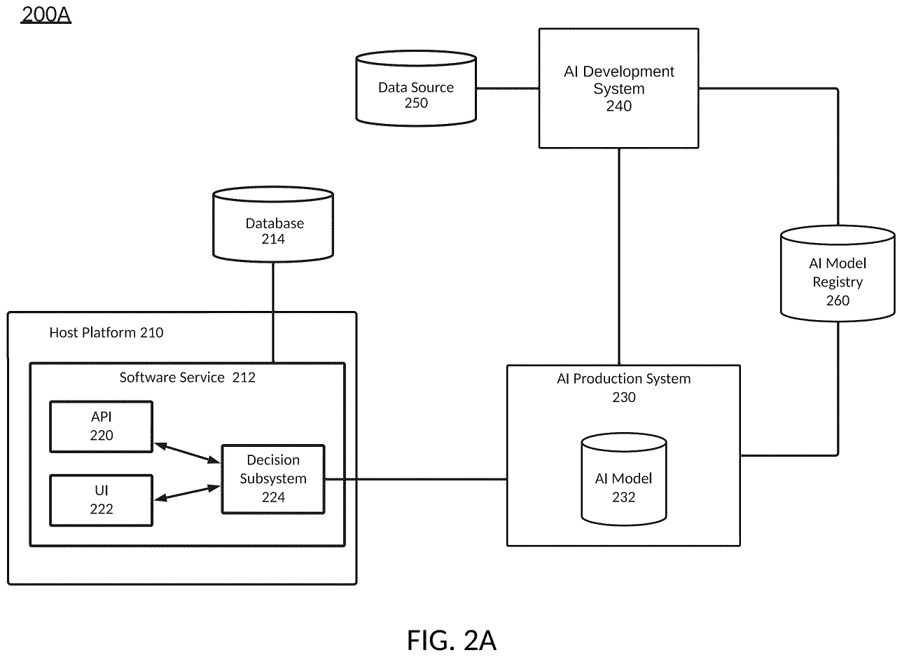

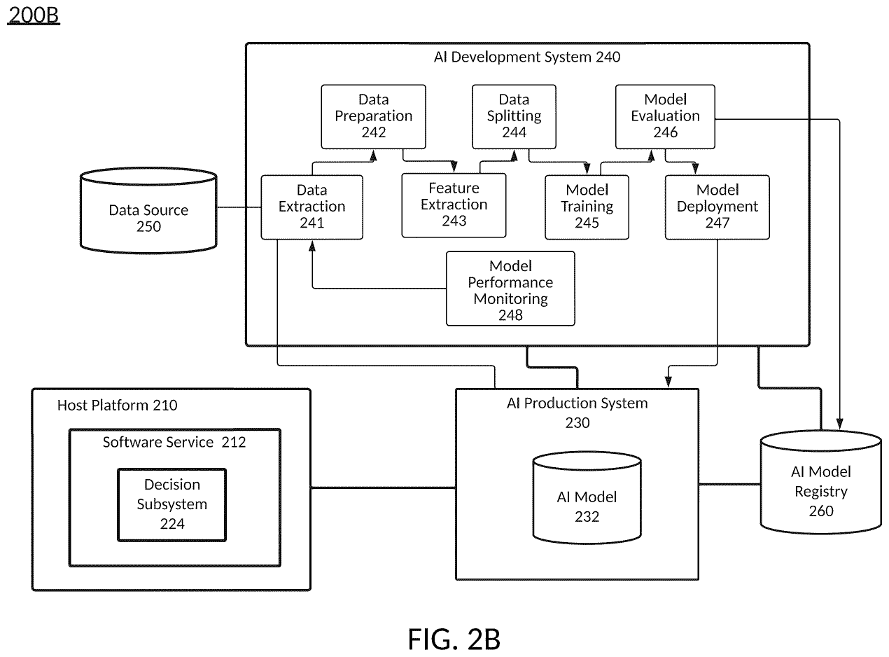

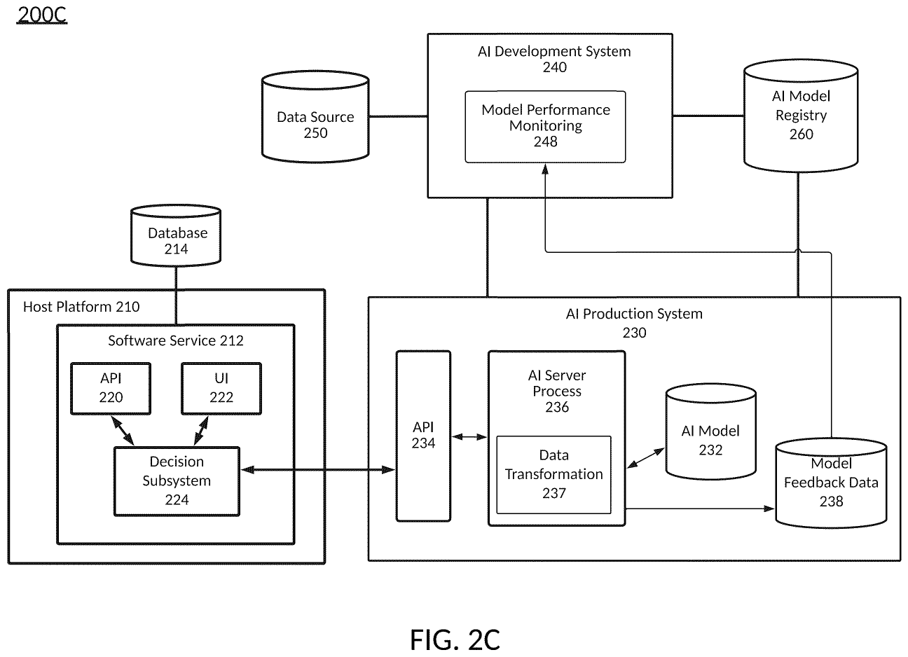

FIG. 2A illustrates an AI network diagram 200A that supports AI-assisted decision points in a software service executing on a computer. While the example instant solution shown utilizes a neural network, which is a type of machine learning (M L) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 (see FIGS. 1A, 2A) , executing on host platform 210 (see FIGS. 1A) may provide at least one A PI 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of A Pls 220 send data to at least one decision subsystem 224 of the software service 212 to assist in decision-making. In some examples and features of the instant solution, the software service 212 stores data included in A PI requests or data generated during processing the A PI requests into at least one database 214 (see FIGS. 1A, 2A).

Software service 212 may provide at least one user interface (UI) 222, such as a server-side hosted graphical user interface (GUI). In some examples and features of the instant solution, the Uls 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one A PI 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an A PI 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an A PI 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include A PI 220 data from software service 21,2 UI 222 data from software service 212 or data from other software service 212 subsystems (not shown).

Upon receiving the A PI 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

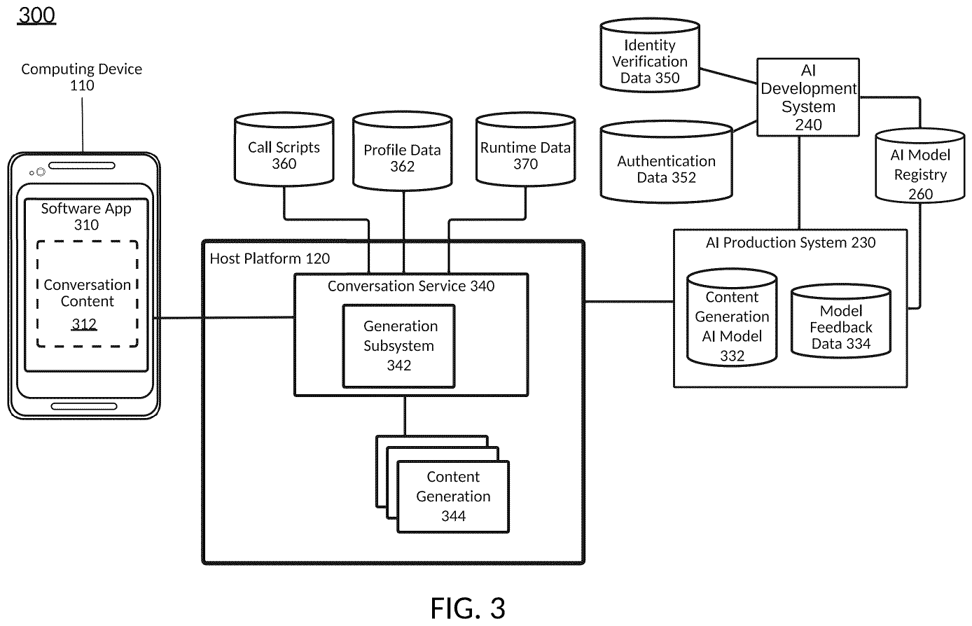

FIG. 3 illustrates an operating environment 300 for a communication service according to the examples and features of the instant solution. In some examples and features of the instant solution, a content generation AI model 332 is trained using at least one of historical call scripts, historical profile data, runtime data including feedback, and the like, to generate conversation content that can be injected into a communication session given a set of feature data transformed from a set of application data and computing device data. The content generation AI model 332 is an example of AI Model 232 (see, for example, FIGS. 2A-2C) . The historical call scripts, historical profile data, runtime data including feedback are examples of data source 250 (see, for example, FIGS. 2A-2C). The training of the content generation AI model 332 may be evaluated based on identity verification data 350, authentication data 352, and the like.

In some examples and features of the instant solution, the content generation AI model 332 is trained using at least one neural network training method such as, but not limited to, gradient descent, stochastic gradient descent, random search, uniform search, basin hopping, and Krylov. In some examples and features of the instant solution, the content generation AI model 332 is a single or multi-layer perceptron neural network, a feed-forward neural network, a radial basis functional neural network, a recurrent neural network, or a modular neural network.

In some examples and features of the instant solution, the content generation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the content generation AI model 332 may include, but is not limited to, internal data sources, external data sources, private data sources, public data sources, historical call scripts, historical profile data, runtime data including feedback, or the like.

In some examples and features of the instant solution, historical call scripts may include, but is not limited to, call scripts previously recorded between the same devices, different devices, and the like. The historical call scripts may include the utterances that are spoken, identifiers of which user spoke which utterances, timestamps of the utterances, and the like. The utterance may include a textual description of the audio from a historical video call, phone call, web call, meeting, or the like. The historical profile data may include profile data of the users that participated in the historical calls including which calls the users participated. The runtime data may include feedback that is automatically captured by the software and/or that is received from a GUI, etc.

The model feedback records in the model feedback data 334 may include, but is not limited to, inputs entered via a GUI which indicate whether the conversation content was spoken by one of the users, was good or bad, etc. The model feedback data 334 may include data that is automatically detected by the software application. For example, the software application may verify whether or not suggested content is spoken by one of the parties by capturing the audio from the communication session, converting it into text, and verifying that the conversation content is included therein.

Once the content generation AI model 332 is trained and validated, it is deployed to an AI production system 230 (see, for example, FIGS. 2A-2C, 3) for use by a conversation service 340. The conversation service 340 is an example of software service 114 or software service 212 (see, for example, FIGS. 1A, 2A-2C).

In some examples and features of the instant solution, software app 310, running on computing device 110, is an example of service client 116 (see FIG. 1A) . The software app 310 may be a teleconferencing software application, a conferencing software application, a meeting software application, a contact center software application, a mobile application, or the like. The software app 310 may enable users to speak with one another over a network such as a cellular telephone network, the Internet, and the like. The software app 310 may also display content on a GUI of the software app 310, such as conversation content 312. The software app 310 may also display content generated by the content generation AI model 332.

In some examples and features of the instant solution, the conversation service 340 receives data from the software app 310. The data may include, but is not limited to, call scripts, images, text, audio, and the like.

Additionally, the conversation service 340 receives data about the computing device 110. The device data may include, but is not limited to, the media access control (MAC) address and the source internet protocol (IP) address of the computing device.

For example, the conversation service 340 may host a conversation between a first device and a second device. During the conversation, the conversation service 340 may instantiate a generation subsystem 342 which listens to the conversation (e.g., words, phrases, utterances, etc.) that are spoken during the conversation and determines whether or not to generate conversation content. When the generation subsystem 342 determines to generate conversation content, the generation subsystem 342 executes a process for content generation 344 which may invoke the content generation AI model 332 in the AI production system 230 for generative content that can be displayed, spoken, or the like, within the conversation. The invocation to the AI production system 230 may include speech data spoken within the conversation, call scripts, and the like. The content for the call may include data from database of call scripts 360, a database of profile data 362, a database of runtime data 370, and the like, in addition to the speech data.

In response to receiving the invocation, the content generation AI model 332 may generate conversation content that may include at least one of an utterance, a phrase, a script, and the like, which can be output during the conversation. The conversation content may be provided to the conversation service 340 and output to a GUI of the software app 310, spoken by a talking bot via the software app 310, and the like.

According to various examples and features of the instant solution, the system described herein may detect a topic of conversation that is currently being discussed during a live teleconference, telephone call, meeting, video call, etc., and automatically overtake control of the conversation and output generative content from an AI system.

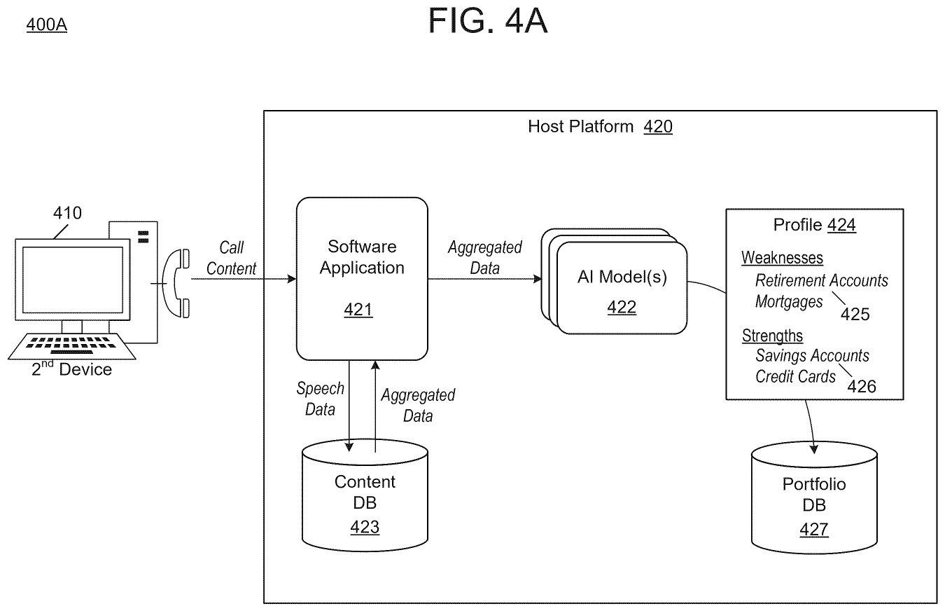

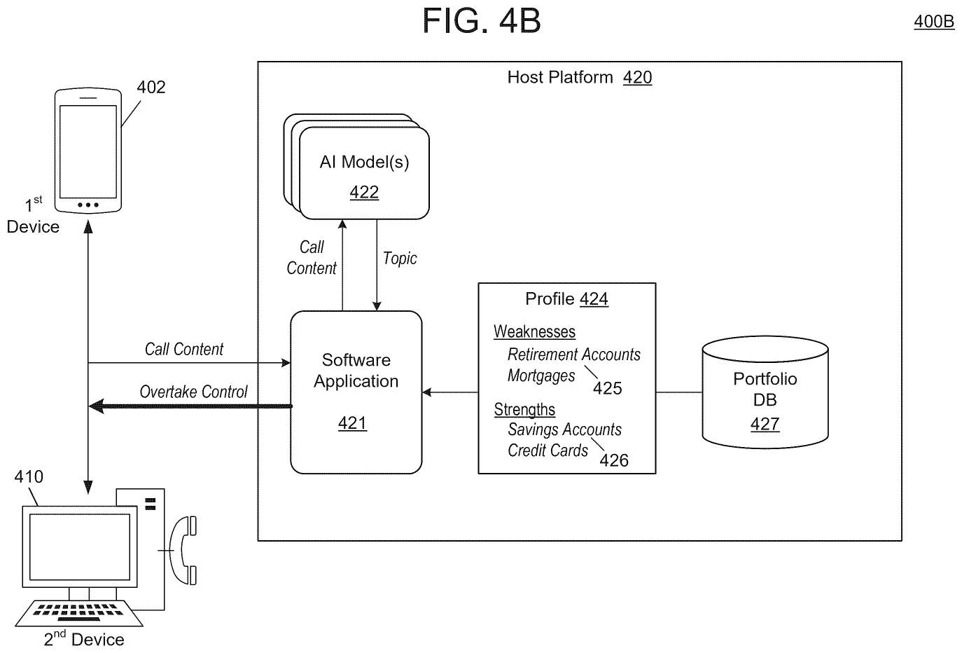

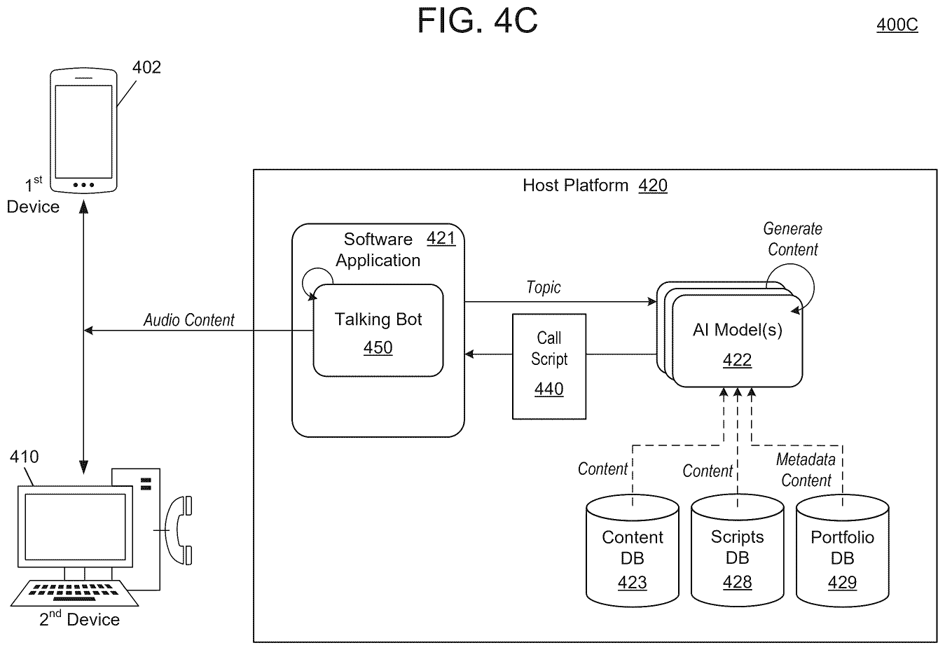

FIG. 4A illustrates a process 400A of building a profile of topics of weakness according to the examples and features of the instant solution. Referring to FIG. 4A, a host platform 420 may host a software application 421 which can host or otherwise execute a telecommunication session between devices such as the first device and the second device described with respect to the example of FIG. 1B. Here, the host platform 420 may correspond to a cloud platform, a web server, an on-premises server, a distributed system, and the like. The software application 421 may be a mobile application, a web application, or the like. In this example, a device (eg., referred to herein as a second device 410 in FIGS. 4A-4C) is conducting a communication session with one or more other devices (not shown) through the software application 421. The communication session may include a telephone call, a video call, a teleconference, a meeting, or the like.

The software application 421 may capture conversation content from the communication session with the second device 410 and store the conversation content within a database, such as content DB 423. The content DB 423 can be used to aggregate the conversation content over time. The aggregated conversation content can be input by the software application 421 to at least one AI model(s) 422 which is configured to identify the topics being discussed during the conversation. The at least one AI model(s) 422 may also identify topics that are weaknesses and topics that are strengths of the participant speaking with the second device 410. Here, the software application 421 may build a profile 424 for the participant of the second device 410. The software application 421 may store a list of topics that are weaknesses 425 and a list of topics that are strengths 426 in the profile 424 and commit the profile to a database, such as portfolio DB 427.

In this example, the at least one AI model(s) 422 may be trained to identify topics being discussed within the communication session. The training data for training the at least one AI model(s) 422 to identify topics may include words, phrases, etc., mapped to topics. The training data may include call scripts, etc. The at least one AI model(s) 422 may be further trained to identify which topics are weaknesses and which topics are strengths of the participant based on the quality of the conversation content that is generated by the participant during the conversation with respect to different topics. The training data for training the at least one AI model(s) 422 to identify weaknesses and strengths may include examples of conversation content indicating a topic of strength mapped to a name of topic and examples of conversation content indicating a topic of weakness mapped to a name of a topic, etc.

FIG. 4B illustrates a process 400B of determining to overtake control of a communication session according to the examples and features of the instant solution. Referring to FIG. 4B, the second device 410 may conduct a teleconference or other communication session with a first device 402. Here, the communication session may be conducted via the software application 421. Participants may use the first device 402 and the second device 410 to speak/converse with one another through the software application 421.

As the communication is being conducted, in real-time, audio recording devices (e.g., microphones, etc.) on the first device 402 and/or the second device 410 may capture/record audio content spoken during the communication session. The software may convert the audio content into digital conversation content (e.g., text, etc.) using an analog-to-digital converter, a speech-to-text converter, and the like. The conversation content may be provided to the software application 421 on the host platform 420 and passed to the at least one AI model(s) 422. For example, the at least one AI model(s) 422 may identify a topic of conversation that is currently being discussed during the communication session and notify the software application 421 of the topic. When the topic changes, the at least one AI model(s) 422 may update the topic and notify the software application 421 of the updated topic.

According to various examples and features of the instant solution, the software application 421 may compare the current topic of conversation to the topics stored within the profile 424 of the participant of the communication session (second device 410). The profile 424 may be retrieved from the portfolio DB 427 and the topic may be compared to the list of topics that are weaknesses 425 in the profile 424. When the software application 421 matches the current topic to a topic of weakness within the weaknesses 425 stored within the profile 424, the software application 421 may determine to overtake control of the conversation. In some examples and features of the instant solution, the software application 421 may wait until there is a pause in the conversation, or otherwise notify at least one of the devices (e.g., the second device 410) that the software application 421 is taking over the communication session.

The software application 421 may output a request/notification that indicates the software application 421 is ready to take over the communication session. For example, the software application 421 may display a notification on a GUI of the software application displayed on the second device 410. In this example, the user of the second device 410 may confirm/accept the overtaking of the communication session by the software application 421 by inputting a command via the GUI of the software application 421.

With the communication session overtaken, or prior to overtaking the communication session, the software application 421 may generate content about the topic of weakness to be spoken during the communication session. For example, the software application 421 may input the topic, the speech data from the conversation, and the like, into the at least one AI model(s) 422. In response, the at least one AI model(s) 422 may generate conversation content based on the input data from the communication session. In some examples and features of the instant solution, the at least one AI model(s) 422 may prioritize the most-recent speech data from the communication session (e.g., the last 60 seconds, 90 seconds, etc.).

FIG. 4C illustrates a process 400C of generating and outputting content during the communication session according to the examples and features of the instant solution. Referring to FIG. 4C, the at least one AI model(s) 422 may generate conversation content such as a call script 440 with conversation content about the current topic based on the content from the conversation and based on data from at least one of the content DB 423, a scripts DB 428, a portfolio DB 429, and the like. The content DB 423 may include previous content spoken during this communication session. The scripts DB 428 may include previous call scripts that are used by either of the participants or other/different participants. The portfolio DB 429 may include metadata about one of the participants such as demographic information, family history, preferences, and the like.

The call script 440 generated by the at least one AI model(s) 422 may include content that is to be spoken aloud during the communication session. Here, the software application 421 may automatically output the spoken content via a talking bot 450. In some examples and features of the instant solution, prior to outputting the content, the software application 421 may request permission by displaying an indicator on the second device 410 and waiting for a user to confirm the takeover by inputting a command with respect to the indicator.

When outputting the content to the communication session via the talking bot 450, the software application may mute at least one of the first device 402 and the second device 410 preventing audio from being spoken by either of the participants or one of the participants. With the at least one device muted, the software application 421 may cause the talking bot 450 to speak the content from the call script 440 aloud. In some examples and features of the instant solution, the at least one AI model(s) 422 may also determine a voice to use by the talking bot 450 when speaking the conversation content from the call script 440. For example, the voice may be a voice that mimics the speaking style (eg., tone, cadence, style, etc.) of the participant of the second device 410.

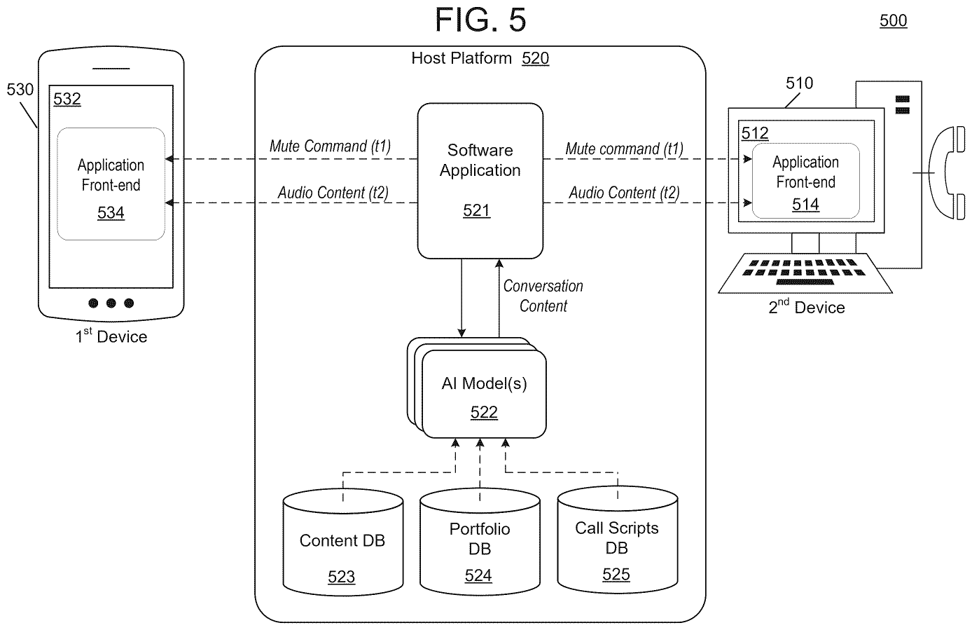

FIG. 5 illustrates a process 500 of muting a plurality of devices participating in a communication session according to the examples and features of the instant solution. Referring to FIG. 5, a software application 521 hosted by a host platform 520 may correspond to the software application 421 shown in the examples of FIGS. 4A-4C . In this example, the software application 521 may call at least one AI model(s) 522 to generate conversation content that is to be spoken by a talking bot (not shown in this example) during a communication session being conducted between a first device 530 with a display device 532 and a second device 510 with a display device 512. In this example, the conversation content may be generated based on speech data from the communication session and content/metadata from databases, such as at least one of a content DB 523, a portfolio DB 524, and a call scripts DB 525.

In this example, the software application 521 may represent a back-end of the software application that is hosted by the host platform 520. Here, a front-end of the software application 521 may be installed or otherwise running on the devices participating in the communication session. In this example, the software application 521 may send a mute command to the front-end of the software which causes the front-end of the software application to mute an audio input capability of the respective device.

For example, the software application 521 may send an instruction to an application front-end 534 on the first device 530 which causes the application front-end 534 to mute the audio captured by the microphone of the first device 530. In addition, the software application 521 may simultaneously send a similar instruction to an application front-end 514 on the second device 510 which causes the application front-end 514 to mute the audio captured by the microphone of the second device 510. The mute instruction may identify a start time, a stop time, and the like of the muting process. In some examples and features of the instant solution, the parameters of the muting operation may be displayed on the display device 532 and the display device 512 by the application front-ends. After submitting the mute command, the software application 521 may wait until the first device 530 and the second device 510 are muted and output the content generated by the at least one AI model(s) 522 via a talking bot.

In an example of the instant solution, the software application 521 captures speech data from a communication session between a first device 530 and a second device 510. This captured data is processed through the AI model(s) 522, where advanced natural language processing techniques filter noise and segment the input into meaningful conversational units.

Using the speech data and call scripts, the system employs a retrieval-augmented generation (RAG) framework. The RAG framework begins with the captured speech which is preprocessed into semantic embeddings that encapsulate the meaning of the spoken content. These embeddings serve as input queries for the RAG framework, which retrieves relevant information from various databases, including the content DB 523, call scripts DB 525, and portfolio DB 524. This retrieval step ensures that the system accesses predefined conversation content and also historical data, participant-specific information, and relevant contextual details. Once the relevant data is retrieved, the RAG framework combines it with the real-time conversation context to generate content dynamically. The AI model(s) 522 employs this retrieved data to refine its understanding of the current topic and produce tailored responses. The generative component of the RAG framework then synthesizes this content into actionable outputs, such as call scripts, conversation prompts, or summaries, which can be displayed or spoken aloud through a talking bot

In an example of the instant solution, the AI model(s) 522 retrieves relevant contextual information from the content DB 523, which is structured to store conversation histories, predefined scripts, and other relevant materials categorized by topics, context, or participant profiles. Using semantic search methods, such as embedding-based retrieval, the AI model identifies stored content with high relevance to the query input, involving matching the semantic meaning of the input query to similar entries in the database rather than relying solely on keyword matches. When speech data is captured during the communication session, the AI model processes the input to extract semantic meaning, such as keywords, phrases, or contextual cues. These elements are then used as query inputs to access the content DB 523. The AI model applies filters based on metadata associated with the content, such as participant-specific preferences, conversation history, or previously identified topics. When the most relevant data is retrieved, it is combined with the current speech data and processed further by the AI model to create responses or outputs tailored to the ongoing communication session.

The input is aligned with predefined topics stored in the profile contained in the participant's metadata. The topic is identified by comparing semantic embeddings of the speech input against the participant's profile data, which contains triggers for specific conversational topics. When speech data is captured during a communication session, it is processed by the AI model(s) 522 to extract meaningful text representations, converting the audio input into text using speech-to-text algorithms. Then, it encodes the text into semantic embeddings, which are dense vector representations capturing the contextual and semantic meaning of the words and phrases. Similarly, the participant's profile, which includes predefined triggers for topics such as “retirement planning” or “card rewards,” is preprocessed into semantic embeddings. The AI model then performs a similarity comparison, using mathematical measures like cosine similarity, to determine how closely the speech input aligns with the triggers in the profile. A high similarity score indicates that the speech input is semantically related to a specific trigger. When the score exceeds a predefined threshold, the corresponding topic is identified as the focus of the current conversation. When no clear match is found, the model can use fallback mechanisms, such as querying additional contextual data from the content database or analyzing historical conversation data to infer the most likely topic. Over time, the participant's profile can be dynamically refined by incorporating new triggers or feedback from prior interactions. Once the topic is identified, it is integrated into the conversation's broader context, guiding actions such as retrieving related content, overtaking the conversation, or generating tailored responses.

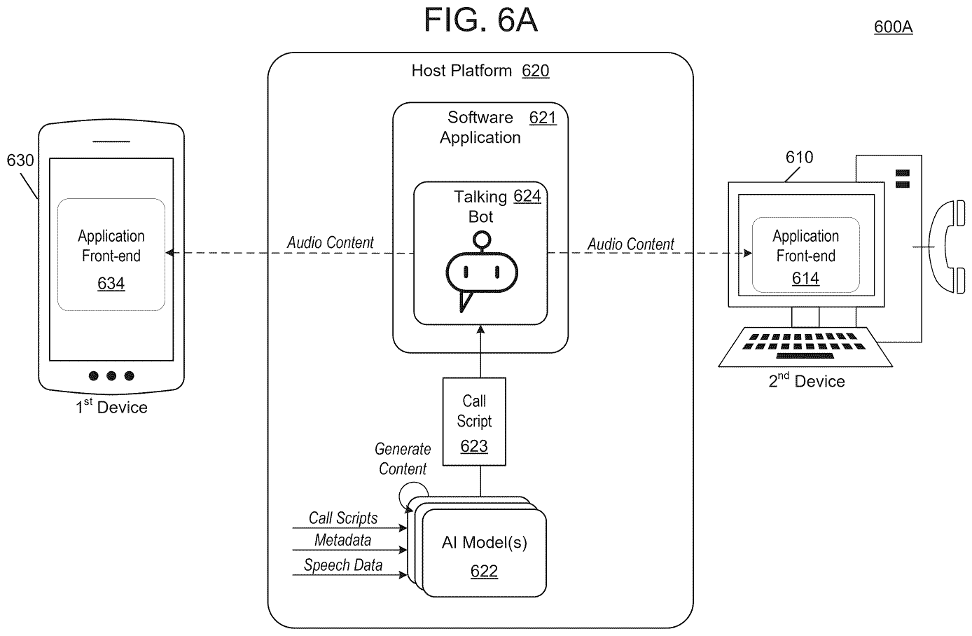

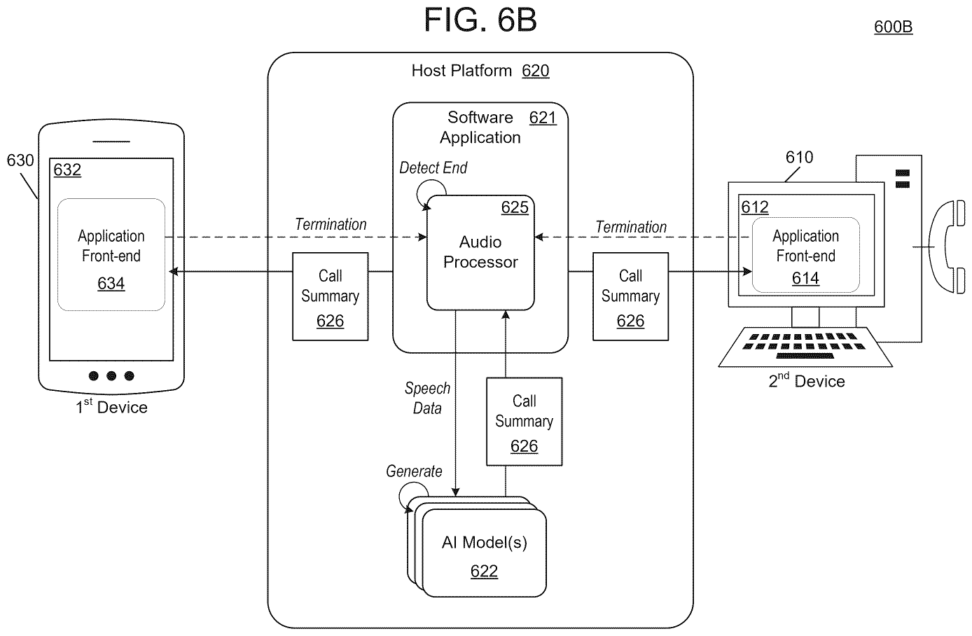

Once the topic is identified, the AI model(s) 522 determines whether to overtake control of the conversation by evaluating the identified topic against a control threshold defined in the participant's profile. When control overtaking is triggered, the AI model(s) 522 generates new conversational content by combining the retrieved contextual data, the current topic, and historical interaction data stored in the content DB 523. The AI model(s) 522 determines whether to overtake control of the conversation by evaluating the current topic of discussion against predefined criteria stored in the participant's profile. During a communication session, speech data is continuously captured and processed to identify the topic being discussed. The AI model(s) 522 analyzes this speech data using natural language processing techniques to derive semantic embeddings, which represent the contextual meaning of the spoken content. The identified topic is then compared to a list of topics marked as weaknesses in the participant's profile, which is stored in the portfolio database. These weaknesses are predefined based on historical conversation data. The AI model identifies them during training as topics where the participant shows difficulty, such as pauses, incorrect information, or incomplete responses. When the current topic matches a topic in the weakness list, the AI model signals the software application to consider overtaking the conversation. Additional factors, such as participant pauses or other hesitation indicators, may further influence the decision. The system may wait for a natural pause in the conversation before taking control or provide a notification to the participant, allowing them to confirm or reject the overtaking. Once overtaking is initiated, the AI model generates contextually relevant content to address the topic and outputs it via a talking bot, such as a talking bot 624 in FIG. 6A.

The generated conversation content is then forwarded to the talking bot 624 in FIG. 6A, where it is synthesized into a natural voice output. The talking bot may use advanced voice synthesis, which may mimic the participant's voice for a seamless interaction. The generated audio content is delivered to the second device, enabling real-time engagement.

FIG. 6A illustrates a process 600A of outputting content through a talking bot according to the examples and features of the instant solution, and FIG. 6B illustrates 600B a process of generating a call summary according to the examples and features of the instant solution. Referring to FIGS. 6A and 6B, a software application 621 hosted by a host platform 620 may host/conduct a communication session between a first device 630 and a second device 610. In this example, the software application 621 may include a talking bot 624 program that is capable of speaking audio content during the communication session that can be heard by the participants of the first device 630 and the second device 610.

For example, the at least one AI model(s) 622 may receive a portion of speech content from the communication session (eg., the last 2 minutes, the last 5 minutes, the entire conversation, etc.) and generate a call script 623. In some examples and features of the instant solution, the at least one AI model(s) 622 may also ingest additional content and metadata when generating the call script 623 such as historical call scripts, metadata about one of the participants, and the like. The call script 623 may be fed to the talking bot 624 program. The software application 621 may cause the talking bot 624 program to speak audio content which is output via a front-end of the software application such as an application front-end 634 on the first device 630 and an application front-end 614 on the second device 610. The application front-ends may simultaneously play the audio content from the call script 623 spoken by the talking bot 624 program. In some examples and features of the instant solution, the communication session may also be muted during this time.

In the example of FIG. 6A, the at least one AI model(s) 622 generates the call script 623 while the communication session is still occurring/live. The software application 621 may iteratively repeat this process multiple times during the communication session and provide different conversation content (call scripts) that are spoken by the talking bot 624 program during the communication session. When the communication session ends, as shown in the example of FIG. 6B, the at least one AI model(s) 622 may generate a summary of the call based on the entire conversation conducted between the devices during the communication session.

For example, the software application 621 may detect a termination of the communication session based on a signal provided by one or more of the application front-ends which occurs in response to one of the participants “hanging-up”, or otherwise leaving the communication session. The software application 621 may include an audio processor 625 which processes the speech content from the communication session and converts it to sound waves. When the sound waves are below a sound threshold (e.g., 0 dB, 1 dB, etc.) for a predetermined period of time (e.g., 5 seconds, etc.), the audio processor 625 may determine the conversation has ended. There are also other mechanisms for determining the conversation has ended, which are not expressly shown or described herein.

In response to detecting that the communication session has terminated, the software application 621 may aggregate the conversation content from the communication session including any spoken content provided by the talking bot 624 program and input the aggregated conversation content to the at least one AI model(s) 622 along with a prompt which instructs the at least one AI model(s) 622 to generate a summary of the conversation. In response, the at least one AI model(s) 622 generates a call summary 626 which includes speech from the conversation converted into text and identifies which participant spoke the text. The call summary 626 may also identify speech from the conversation spoken by the talking bot 624 program. The software application 621 may display the call summary 626 on a display device 632 of the first device 630 and on a display device 612 of the second device 610.

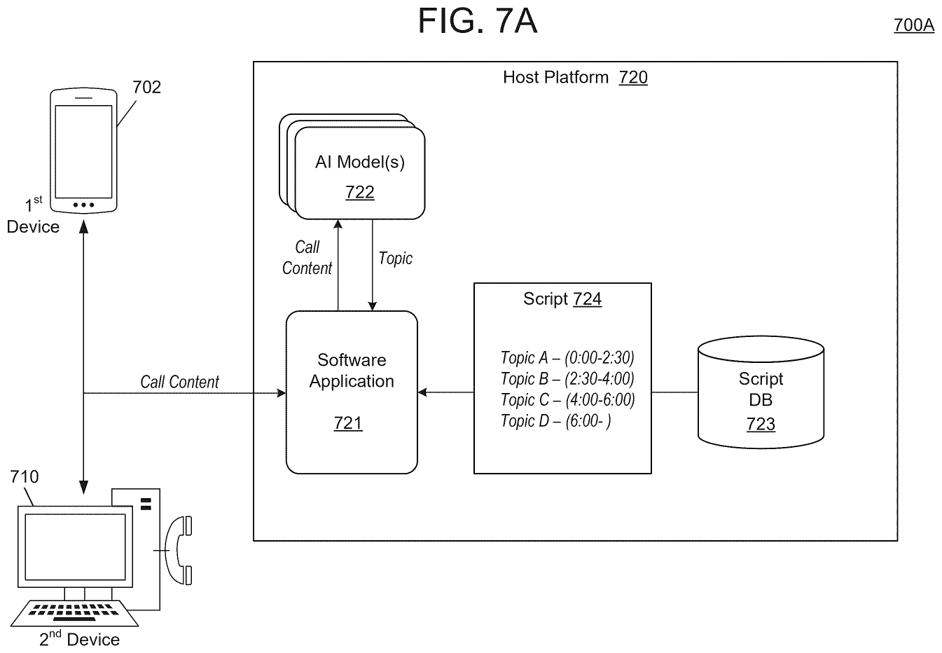

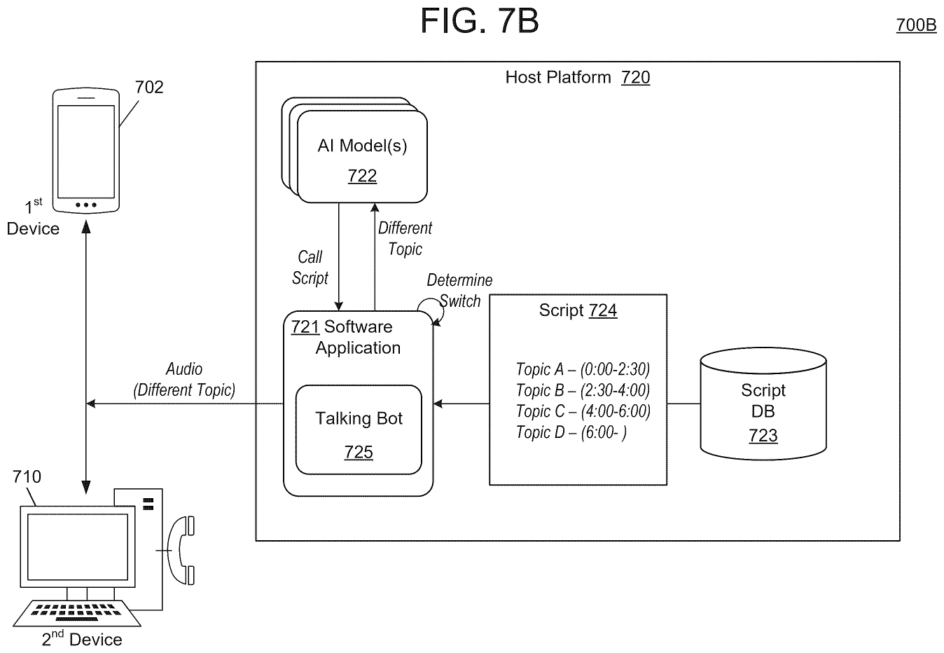

FIGS. 7A-7B illustrate a process of switching topics of conversation during a communication session according to the examples and features of the instant solution. For example, FIG. 7A illustrates a process 700A of comparing a current topic from the call content occurring during a communication session to topics within a predefined call script 724 of the communication session stored in a database, such as script DB 723, and FIG. 7B illustrates a process 700B of switching the topic of conversation based on the predefined call script 724. Referring to FIG. 7A, a host platform 720 may host a software application 721 which is similar to the software application 621 in FIGS. 6A-6B, the software application 421 in FIGS. 4A-4C, and the like. Here, the software application 721 may host a communication session between a first device 702 and a second device 710.

As the communication session is occurring, speech data from the communication session may be captured by the software application 721 and converted into text. The software application 721 may provide the speech data to at least one AI model(s) 722 which can determine a current topic of conversation from the speech data. For example, the at least one AI model(s) 722 may identify a most-recent topic discussed during the communication session. The identified topic may be provided to the software application 721. The software application 721 may also keep a clock/timestamps from the communication session such that the software application 721 can determine how long the communication session has been occurring.

Using the topic and the clock, the software application 721 can compare the topic identified by the at least one AI model(s) 722 to topics that are stored within the predefined call script 724, along with periods of time when the topics are to be discussed. For example, the predefined call script 724 indicates that topic A is to be discussed from the beginning of the communication session until the 2 minute and 30 second mark of the communication session, etc. When the period of time corresponding to a topic has expired in the predefined call script 724 but the topic is still being discussed, or when the topic is not included in the list of topics in the predefined call script 724, the software application 721 may determine to switch the topics of conversation.

Referring now to FIG. 7B, in response to determining to switch the topic of conversation, the software application 721 may provide speech data from the communication to the at least one AI model(s) 722 and an identifier of a different topic to be discussed which may be identified by the software application 721 from the predefined call script 724. The at least one AI model(s) 722 may generate conversation content such as a call script about the different topic and provide the call script to the software application 721. In response, the call script about the different topic may be spoken aloud during the communication session by a talking bot 725 program of the software application 721. In doing so, the software application 721 can dynamically switch the topic of conversation to ensure that the timing guidelines in the predefined call script 724 are adhered to by the participants on the first device 702 and the second device 710.

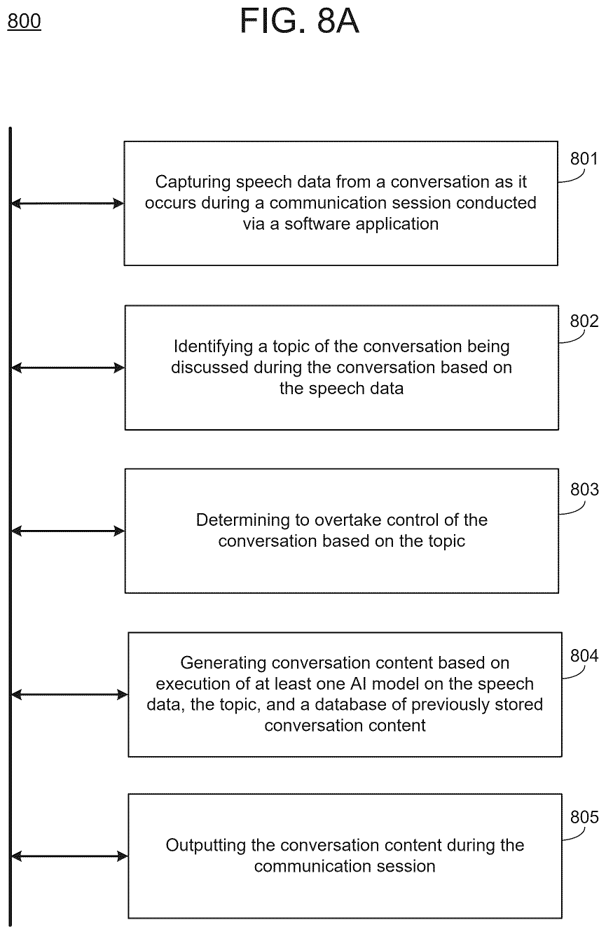

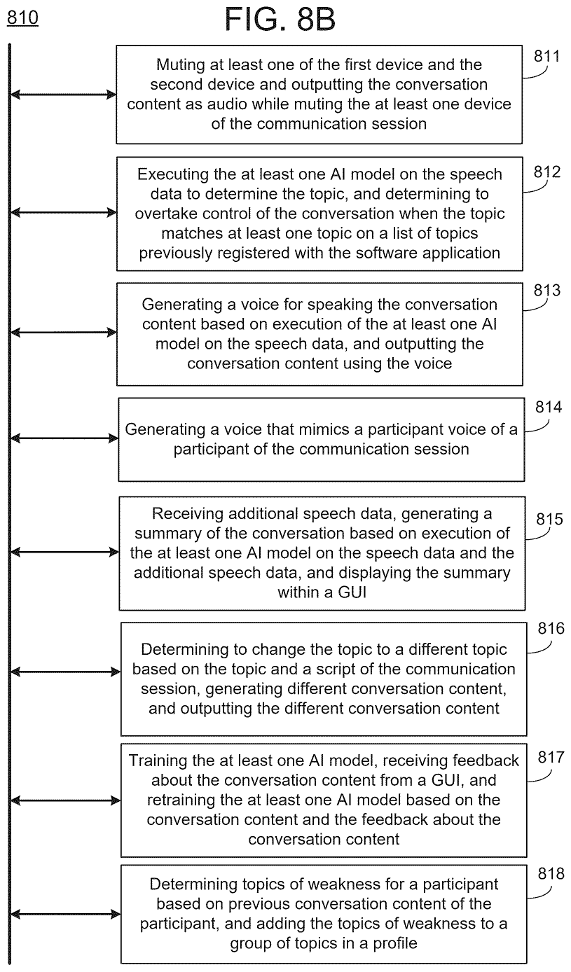

FIG. 8A illustrates a method 800 of overtaking control of a communication session according to the examples and features of the instant solution. As an example, the method 800 may be performed by a computing system, a software application, a server, a cloud platform, a combination of systems, and the like. Referring to FIG. 8A, in 801, the method may include capturing, by a software application, speech data from a conversation as it occurs during a communication session conducted between a first device and a second device via the software application. In 802, the method may include identifying, by the software application, a topic of the conversation being discussed during the conversation based on the speech data.

In 803, the method may include determining to overtake control of the conversation by the software application based on the topic. For example, the software application may read a profile of a participant of the conversation and determine that the current topic being discussed in the conversation matches a topic of weakness in the profile of the participant. In this case, the software application may determine to overtake control in response to the pause. In 804, the method may include generating conversation content by the software application based on execution of at least one artificial intelligence (AI) model on the speech data, the topic of the conversation, and a database of previously stored conversation content. In 805, the method may include outputting, by the software application, the conversation content through a talking bot during the communication session.

FIG. 8B illustrates a method 810 of overtaking control of a communication session according to additional examples and features of the instant solution. As an example, the method 810 may be performed by a computing system, a software application, a server, a cloud platform, a combination of systems, and the like. Referring to FIG. 8B, in 811, the method may include muting, by the software application, audio from at least one of the first device and the second device in response to the determination to overtake control, and outputting the conversation content as audio while muting the at least one of the first device and the second device. In 812, the method may include executing the at least one AI model on the speech data to determine the topic, and the determining to overtake control of the conversation comprises determining that the topic matches at least one topic on a predefined list of topics previously registered with the software application.

In 813, the method may include generating a voice for speaking the conversation content based on execution of the at least one AI model on the speech data, and outputting the conversation content using the voice. In 814, the method may include generating a voice that mimics a participant voice of a participant of the communication session. In 815, the method may include receiving additional speech data of a remainder of the communication session, generating a summary of the conversation based on execution of the at least one AI model on the speech data and the additional speech data, and displaying the summary of the conversation within a GUI of the software application.

In 816, the method may include determining to change the topic to a different topic based on the topic and based on a script of the communication session, generating different conversation content based on execution of the at least one AI model on the speech data and the different topic, and outputting, by the software application, the different conversation content during the communication session. In 817, the method may include training the at least one AI model based on at least one of historical conversation content, historical call scripts, and historical profile data, receiving feedback about the conversation content from a graphical user interface (GUI) of the software application, and retraining the at least one AI model based on the conversation content and the feedback about the conversation content. In 818, the method may include determining topics of weakness for a participant of the communication session based on execution of the at least one AI model on previous conversation content of the participant, and adding the topics of weakness to a group of topics in a profile of the participant prior to conducting the communication session.

In some examples and features of the instant solution, the receiving may include receiving audio from the call while the call is in progress, converting the audio into text based on execution of a speech-to-text converter, and determining the focus of the call has shifted based on keywords identified within the text. In some examples and features of the instant solution, the identifying may include identifying a plurality of topics from a meeting summary stored in a software application, and the determining comprises comparing keywords in the received conversation data to keywords in the meeting summary. In some examples and features of the instant solution, the dynamically generating may include dynamically moving the display content of the first topic from its initial location to a different location on the user interface and presenting display content of the second topic on the user interface at the initial location of the display content of the first topic.

In some examples and features of the instant solution, the dynamically generating may include dynamically instantiating a new piece of content corresponding to the second topic on the user interface at a different location than the display content of the first topic on the user interface. In some examples and features of the instant solution, the identifying may include identifying a plurality of topics of interest to be discussed during the call and the displaying the dashboard comprises displaying a plurality of modules of content for the plurality of topics of interest, respectively, on the user interface simultaneously. In some examples and features of the instant solution, the dynamically generating may include rearranging the plurality of modules of content for the plurality of topics of interest based on execution of the GenAI model on the second topic.

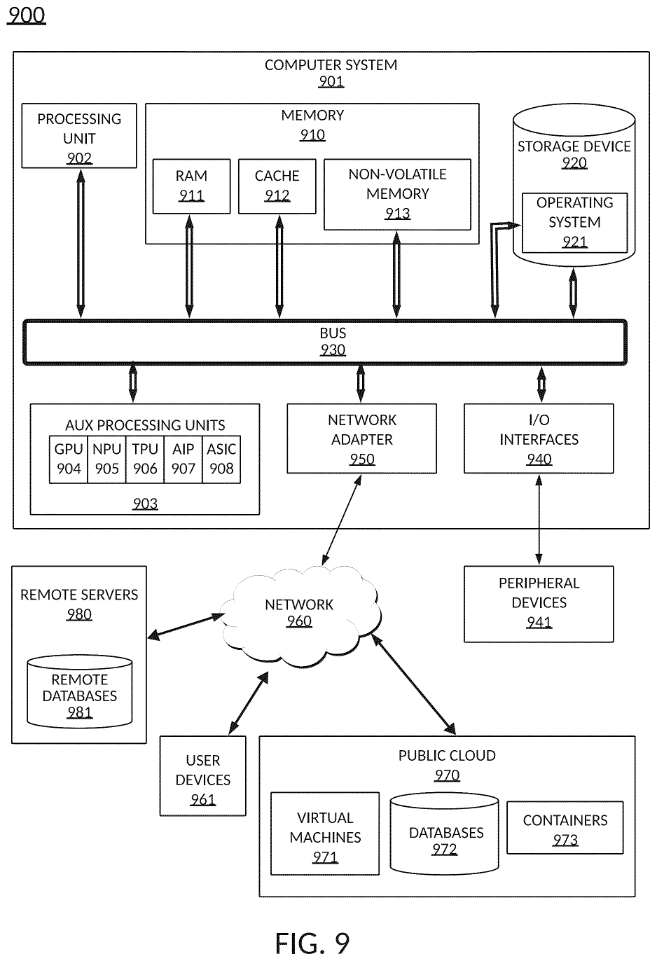

The examples and features of the instant solution may be implemented in at least one of the elements described or depicted herein, including for example, the elements described or depicted in FIG. 9. These examples and features may further be implemented in hardware, in a computer program executed by a processor, in firmware, or in a combination of the above. A computer program may be embodied on a computer readable medium, such as a storage medium. For example, a computer program may reside in random access memory (RAM) , flash memory, read-only memory (ROM), erasable programmable read-only memory (EPROM), electrically erasable programmable read-only memory (EEPROM) , registers, hard disk, a removable disk, a compact disk read-only memory (CD-ROM) , or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 9 illustrates an example computer system architecture, which may represent or be integrated in any of the above-described components, etc.

FIG. 9 illustrates a computing environment according to the instant solution's example features, structures, or characteristics. FIG. 9 is not intended to suggest any limitation as to the scope of use or functionality of features, structures, or characteristics of the instant solution of the application described herein. Regardless, the computing environment 900 can be implemented to perform any of the functionalities described herein. In computing environment 900, there is a computer system 901, operational within numerous other general-purpose or special-purpose computing system environments or configurations.

Computer system 901 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 960 or querying a database. Depending upon the technology, the performance of a computer-implemented method may be distributed among multiple computers and among multiple locations. However, in this presentation of the computing environment 900, a detailed discussion is focused on a single computer, specifically computer system 901, to keep the presentation as simple as possible.

Computer system 901 may be located in a cloud, even though it is not shown in a cloud in FIG. 9. On the other hand, computer system 901 may not be in a cloud except to any extent as may be affirmatively indicated. Computer system 901 may be described in the general context of computer system-executable instructions, such as program modules, executed by a computer system 901. Generally, program modules may include routines, programs, objects, components, logic, data structures, and so on that perform tasks or implement certain abstract data types. A s shown in FIG. 9, computer system 901 in computing environment 900 is shown in the form of a general-purpose computing device. The components of computer system 901 may include but are not limited to, at least one processor or processing unit 902, a system memory 910, and a bus 930 that couples various system components, including system memory 910 to processing unit 902.

Processing unit 902 includes at least one computer processor of any type now known or to be developed. The processing unit 902 may contain circuitry distributed over multiple integrated circuit chips. The processing unit 902 may also implement multiple processor threads and multiple processor cores. Cache 912 is a memory that may be in the processor chip package(s) or located “off-chip,” as depicted in FIG. 9. Cache 912 is typically used for data or code accessed by the threads or cores running on the processing unit 902. In some computing environments, processing unit 902 may be designed to work with qubits and perform quantum computing.

The Auxiliary Processing Units (A PU) 903 may contain at least one Graphics Processing Unit (GPU) 904, Neural Processing Unit (NPU) 905, Tensor Processing Unit (TPU) 906, AI Processor (AIP) 907, or other Application Specific Integrated Circuit (ASIC) 908. The at least one APU 903 may contain circuitry distributed over multiple integrated circuit chips. The APU 903 may implement multiple processor threads and multiple processor cores. The APU 903 may include at least one of onboard memory, onboard memory cache, and onboard instruction cache. The APU may be communicatively coupled to the system bus 930 and configure to communicate with other system components, including a processing unit 902, system cache 912, RAM 911, non-volatile RAM 913, operating system 921, Network adapter 950, and Input/Output interfaces 940. In some computing environments, at least one of the at least one A PU 903 may be designed to work with qubits and perform quantum computing.

Memory 910 is any volatile memory now known or to be developed in the future. Examples include dynamic random-access memory (RAM) 911 or static type RAM 911. Typically, the volatile memory is characterized by random access, but this may not be the characterization unless affirmatively indicated. In computer system 901, memory 910 is in a single package. It is internal to computer system 901, but alternatively or additionally, the volatile memory may be distributed over multiple packages and/or located externally with respect to computer system 901. By way of example, memory 910 can be provided for reading from and writing to a non-removable, non-volatile magnetic media (shown as storage device 920, and typically called a “hard drive”). Memory 910 may include at least one program product having a set (e.g., at least one) of program modules configured to carry out the functions of various features, structures, or characteristics of the instant solution of the application. A typical computer system 901 may include cache 912, a specialized volatile memory generally faster than RAM 911 and generally located closer to the processing unit 902. Cache 912 stores frequently accessed data and instructions accessed by the processing unit 902 to speed up processing time. The computer system 901 may also include non-volatile memory 913 in the form of ROM, PROM, EEPROM, and flash memory. Non-volatile memory 913 often contains programming instructions for starting the computer, including the basic input/output system (BIOS) and information to start the operating system 921.

Computer system 901 may include a removable/non-removable, volatile/non-volatile computer storage device 920. For example, storage device 920 can be a non-removable, non-volatile magnetic media (not shown and typically called a “hard drive”). At least one data interface can connect it to the bus 930. In features, structures, or characteristics of the instant solution where computer system 901 has a large amount of storage (for example, where computer system 901 locally stores and manages a large database), then this storage may be provided by peripheral storage devices 920 designed for storing very large amounts of data, such as a storage area network (SAN) that is shared by multiple, geographically distributed computers.

The operating system 921 is software that manages computer system 901 hardware resources and provides common services for computer programs. Operating system 921 may take several forms, such as various known proprietary operating systems or open-source Portable Operating System Interface type operating systems that employ a kernel.

The bus 930 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 930 is the signal conduction path that allows the various components of computer system 901 to communicate.

Computer system 901 may communicate with at least one peripheral device, 941, via an input/output (I/O) interface, 940. Such devices may include a keyboard, a pointing device, a display, etc.; at least one device that enables a user to interact with computer system 901; and/or any devices (e.g., network card, modem, etc.) that enable computer system 901 to communicate with at least one other computing devices. Such communication can occur via I/O interface 940. As depicted, I/O interface 940 communicates with the other components of computer system 901 via bus 930.

Network adapter 950 enables the computer system 901 to connect and communicate with at least one network 960, such as a local area network (LAN), a wide area network (WAN), and/or a public network (e.g., the Internet). It bridges the computer's internal bus 930 and the external network, exchanging data efficiently and reliably. The network adapter 950 may include hardware, such as modems or Wi-Fi signal transceivers, and software for packetizing and/or de-packetizing data for communication network transmission. Network adapter 950 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 960 is any computer network that can receive and/or transmit data. Network 960 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 960 may be replaced and/or supplemented by LA Ns designed to communicate data between devices in a local area, such as a Wi-Fi network. The network 960 typically includes computer hardware such as copper transmission cables, optical transmission fibers, wireless transmission, routers, firewalls, switches, gateway computers, edge servers, and network infrastructure known now or to be developed in the future. Computer system 901 connects to network 960 via network adapter 950 and bus 930.

User devices 961 are any computer systems used and controlled by an end user in connection with computer system 901. For example, in a hypothetical case where computer system 901 is designed to provide a recommendation to an end user, this recommendation may typically be communicated from network adapter 950 of computer system 901 through network 960 to a user device 961, allowing user device 961 to display, or otherwise present, the recommendation to an end user. U ser devices can be a wide array, including personal computers, laptops, tablets, hand-held, mobile phones, etc.

A public cloud 970 is an on-demand availability of computer system resources, including data storage and computing power, without direct active management by the user. Public clouds 970 are often distributed, with data centers in multiple locations for availability and performance. Computing resources on public clouds 970 are shared across multiple tenants through virtual computing environments comprising virtual machines 971, databases 972, containers 973, and other resources. A container 973 is an isolated, lightweight software for running a software application on the host operating system 921. Containers 973 are built on top of the host operating system's kernel and contain software applications and some lightweight operating system A Pls and services. In contrast, virtual machine 971 is a software layer with an operating system 921 and kernel. Virtual machines 971 are built on top of a hypervisor emulation layer designed to abstract a host computer's hardware from the operating software environment. Public clouds 970 generally offers databases 972, abstracting high-level database management activities. At least one element described or depicted in FIG. 9 can perform at least one of the actions, functionalities, or features described or depicted herein.

Remote servers 980 are any computers that serve at least some data and/or functionality over a network 960, for example, WAN, a virtual private network (VPN), a private cloud, or via the Internet to computer system 901. These networks 960 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 980 can also host remote databases 981, with the database located on one remote server 980 or distributed across multiple remote servers 980. Remote databases 981 are accessible from database client applications installed locally on the remote server 980, other remote servers 980, user devices 961, or computer system 901 across a network 960. An AI/ML model described or depicted here may reside fully or partially on any of the elements described or depicted in FIG. 9.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms aligned with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution of at least one of a method, apparatus, computer-readable storage medium system, and other element, structure, component, or device as represented in the attached figures are not intended to limit the scope of the instant solution as claimed but are merely representative of aspects and examples of the instant solution. Any of the components described or depicted herein that perform a same or similar functionality may be a same or similar component. For example, different AI-related components that are described or depicted may be the same AI component.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicatively coupled to the memory, wherein the at least one processor is configured to:
capture, by a software application, speech data from a conversation as it occurs during a communication session conducted between a first device and a second device via the software application;
identify, by the software application, a topic of the conversation being discussed during the conversation based on the speech data;
determine to overtake control of the conversation by the software application based on the topic;
generate conversation content by the software application based on execution of at least one artificial intelligence (AI) model on the speech data, the topic of the conversation, and a database of previously stored conversation content; and
output, by the software application, the conversation content during the communication session in response to the determination to overtake control.

2. The apparatus of claim 1, wherein the at least one processor is further configured to mute, by the software application, audio from at least one of the first device and the second device in response to the determination to overtake control, and output the conversation content as audio while muting the at least one of the first device and the second device.

3. The apparatus of claim 1, wherein the at least one processor is configured to determine the topic based on execution of the at least one AI model on the speech data, and determine to overtake control of the conversation when the topic matches at least one topic on a predefined list of topics previously registered with the software application, wherein an AI agent performs an action related to the determination to overtake control.

4. The apparatus of claim 1, wherein the at least one processor is configured to generate a voice for speaking the conversation content based on execution of the at least one AI model on the speech data, and output the conversation content using the voice.

5. The apparatus of claim 4, wherein the at least one processor is configured to generate a voice that mimics a participant voice of a participant of the communication session.

6. The apparatus of claim 1, wherein the at least one processor is further configured to receive additional speech data of a remainder of the communication session, generate a summary of the conversation based on execution of the at least one AI model on the speech data and the additional speech data, and display the summary of the conversation within a graphical user interface (GUI) of the software application.

7. The apparatus of claim 1, wherein the at least one processor is further configured to determine to change the topic to a different topic based on the topic and based on a script of the communication session, generate different conversation content based on execution of the at least one AI model on the speech data and the different topic, and output, by the software application, the different conversation content during the communication session.

8. The apparatus of claim 1, wherein the at least one processor is further configured to train the at least one AI model based on at least one of historical conversation content, historical call scripts, and historical profile data, receive feedback about the conversation content from a graphical user interface (GUI) of the software application, and retrain the at least one AI model based on the conversation content and the feedback about the conversation content.

9. The apparatus of claim 1, wherein the at least one processor is further configured to determine topics of weakness for a participant of the communication session based on execution of the at least one AI model on previous conversation content of the participant, and add the topics of weakness to a group of topics in a profile of the participant prior to conducting the communication session.

10. A method comprising:
capturing, by a software application, speech data from a conversation as it occurs during a communication session conducted between a first device and a second device via the software application;
identifying, by the software application, a topic of the conversation being discussed during the conversation based on the speech data;
determining to overtake control of the conversation by the software application based on the topic;
generating conversation content by the software application based on execution of at least one artificial intelligence (AI) model on the speech data, the topic of the conversation, and a database of previously stored conversation content; and
outputting, by the software application, the conversation content during the communication session in response to the determination to overtake control.

11. The method of claim 10, further comprising muting, by the software application, audio from at least one of the first device and the second device in response to the determination to overtake control, wherein the outputting the conversation content comprises outputting the conversation content as audio while muting the at least one of the first device and the second device.

12. The method of claim 10, wherein the identifying the topic comprises executing the at least one AI model on the speech data to determine the topic, and the determining to overtake control of the conversation comprises determining that the topic matches at least one topic on a predefined list of topics previously registered with the software application, wherein an AI agent performs an action related to the determining to overtake control.

13. The method of claim 10, wherein the generating the conversation content further comprises generating a voice for speaking the conversation content based on execution of the at least one AI model on the speech data, and the outputting comprises outputting the conversation content using the voice.

14. The method of claim 13, wherein the generating the voice for speaking the conversation content comprises generating a voice that mimics a participant voice of a participant of the communication session.

15. The method of claim 10, further comprising receiving additional speech data of a remainder of the communication session, generating a summary of the conversation based on execution of the at least one AI model on the speech data and the additional speech data, and displaying the summary of the conversation within a graphical user interface (GUI) of the software application.

16. The method of claim 10, further comprising determining to change the topic to a different topic based on the topic and based on a script of the communication session, generating different conversation content based on execution of the at least one AI model on the speech data and the different topic, and outputting, by the software application, the different conversation content during the communication session.

17. The method of claim 10, further comprising training the at least one AI model based on at least one of historical conversation content, historical call scripts, and historical profile data, receiving feedback about the conversation content from a graphical user interface (GUI) of the software application, and retraining the at least one AI model based on the conversation content and the feedback about the conversation content.

18. The method of claim 10, further comprising determining topics of weakness for a participant of the communication session based on execution of the at least one AI model on previous conversation content of the participant, and adding the topics of weakness to a group of topics in a profile of the participant prior to conducting the communication session.

19. A computer-readable storage medium comprising program instructions which when executed by a processor cause the processor to perform:
capturing, by a software application, speech data from a conversation as it occurs during a communication session conducted between a first device and a second device via the software application;
identifying, by the software application, a topic of the conversation being discussed during the conversation based on the speech data;
determining to overtake control of the conversation by the software application based on the topic;
generating conversation content by the software application based on execution of at least one artificial intelligence (AI) model on the speech data, the topic of the conversation, and a database of previously stored conversation content; and
outputting, by the software application, the conversation content during the communication session in response to the determination to overtake control.

20. The computer-readable storage medium of claim 19, wherein the program instructions further cause the processor to perform muting, by the software application, audio from at least one of the first device and the second device in response to the determination to overtake control, wherein the outputting the conversation content comprises outputting the conversation content as audio while muting at least one participant of the communication session.
